(19) United States
(12) Patent Application Publication
(10) Pub. No.: US 2025/0121630 A1
(43) Pub. Date: Apr. 17, 2025

(54) BICYCLE HUB KIT

(71) Applicant: Wei-Yueh CHANG, Taichung City (TW)

(72) Inventor: Wei-Yueh CHANG, Taichung City (TW)

(21) Appl. No.: 18/484,811

(22) Filed: Oct. 11, 2023

(51) Int. Cl. B60B 27/00; B60B 27/02; B60B 27/04; F16D 41/24

(52) U.S. Cl. CPC B60B 27/0057; B60B 27/023; B60B 27/04; F16D 41/24

(57) ABSTRACT

A bicycle hub kit has a hub body, a driver disposed to a first end of the hub body, a sprocket connected to the driver, a clutch sleeve disposed inside the hub body and connected to the driver, and a shaft kit. The shaft kit includes a shaft body, an end base fixed to the shaft body, a ball retainer sleeved on the end base and supporting between the hub body and the end base, and a positioning kit disposed between the end base and the clutch sleeve. The positioning kit can be selected from a sleeve positioning kit and a braking positioning kit. The shaft kit can be detached from the hub body for replacing the positioning kit to transform the bicycle hub kit between with and without a coaster brake.

### BACKGROUND OF THE INVENTION

### 1. Field of the Invention

The present invention relates to a bicycle kit, and more particularly to a bicycle hub kit that has a replaceable shaft kit to transform the bicycle hub kit between with and without a coaster brake.

### 2. Description of Related Art

A bicycle hub kit is a transmission component of a bicycle, is disposed to a center of a rear wheel, surrounds a shaft, and is connected to spokes. When pedals are stamped forwardly, the bicycle hub kit is driven via a chain driving device to drive the rear wheel to rotate forwardly, thereby driving the bicycle forward. When pedals are not stamped, the rear wheel may keep rotating because of inertial motion. Conventional bicycle hub kits may be distinguished into a hub kit without a coaster brake and a hub kit with a coaster brake. The hub kit with a coaster brake substantially comprises a hub body, a driving threaded rod extending into the hub body, an expending nut disposed in the hub body and connected to the driving threaded rod via a threaded engagement, and at least one brake pad disposed between an external surface of the expending nut and an internal peripheral surface of the hub body. When a rider reverses the pedals, the expending nut is driven to move along the driving threaded rod to push the at least one brake pad to move toward and tightly abut against the internal peripheral surface of the hub body to stop the hub body, thereby braking the bicycle.

It is very convenient to brake the bicycle with the hub kit with a coaster brake via reversing the pedals, but the hub kit with a coaster brake is broken easily and is unable to precisely control the strength of brake. If the rider would like to replace the hub kit with a coaster brake by a hub kit without a coaster brake, the spokes connected to the hub kit need to be reconnected, which is time-consuming, laborious, and costly.

To overcome the shortcomings, the present invention provides a bicycle hub kit to mitigate or obviate the aforementioned problems.

### SUMMARY OF THE INVENTION

The present invention relates to a bicycle hub kit that has a replaceable shaft kit to transform the bicycle hub kit between with and without a coaster brake.

The bicycle hub kit comprises a hub body having a first end and a second end, a driver disposed at the first end of the hub body, a sprocket connected to an outer end of the driver, a clutch sleeve moveably disposed inside the hub body, and a shaft kit. The outer end of the driver extends out of the hub body and an inner end thereof extends into the hub body. The clutch sleeve has a first segment extending away from the driver and a second segment adjacent to the driver, surrounding and connected to the inner end of the driver, and having an outer diameter being larger than an outer diameter of the first segment. The shaft kit comprises a shaft body, an end base, a ball retainer, and a positioning kit. The shaft body extends through the hub body and the clutch sleeve. The end base is fixed to and surrounds the shaft body and extends into the second end of the hub body. The ball retainer is sleeved on and surrounds the end base and supports between the hub body and the end base. The positioning kit is disposed between the end base and the clutch sleeve. Wherein the positioning kit is selected from the group consisting of a sleeve positioning kit and a braking positioning kit. The sleeve positioning kit includes a positioning sleeve and a bearing kit. The positioning sleeve is sleeved on and surrounds an external periphery of the first segment of the clutch sleeve. The bearing kit is disposed between the end base and the positioning sleeve and includes a positioning block connected to the shaft body via a threaded engagement and a bearing sleeved on and surrounding the positioning block and having two opposite end surfaces respectively abutting against the end base and the positioning sleeve. The braking positioning kit includes a braking spring set and at least one brake pad. The braking spring set is disposed between the end base and the clutch sleeve and includes a braking spring extending into the first segment of the clutch sleeve. The at least one brake pad is disposed between an internal peripheral surface of the hub body and outer peripheries of the clutch sleeve and the end base. When the positioning kit is the sleeve positioning kit, the clutch sleeve is kept positioned by the positioning sleeve. When the positioning kit is the braking positioning kit, the clutch sleeve is driven to move along the shaft body by the driver.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a bicycle hub kit in accordance with the present invention, wherein a positioning kit is a sleeve positioning kit;

FIG. 2 is an exploded perspective view of the bicycle hub kit in FIG. 1;

FIG. 3 is an enlarged exploded perspective view of a shaft kit with a clutch sleeve of the bicycle hub kit in FIG. 2;

FIG. 4 is a side view in partial section of the bicycle hub kit in FIG. 2;

FIG. 5 is an enlarged side view in partial section of the shaft kit with the clutch sleeve of the bicycle hub kit in FIG. 3;

FIG. 6 is a side view of the clutch sleeve with a positioning sleeve in FIG. 3;

FIG. 7 is an exploded perspective view of a second embodiment of a bicycle hub kit in accordance with the present invention, wherein a positioning kit is a brake positioning kit;

FIG. 8 an enlarged exploded perspective view of a shaft kit of the bicycle hub kit and a clutch sleeve in FIG. 7;

FIG. 9 is a side view in partial section of the bicycle hub kit in FIG. 7;

FIG. 10 is another side view in partial section of the bicycle hub kit in FIG. 7;

FIG. 11 is an enlarged side view in partial section of the shaft kit with the clutch sleeve of the bicycle hub kit in FIG. 7; and

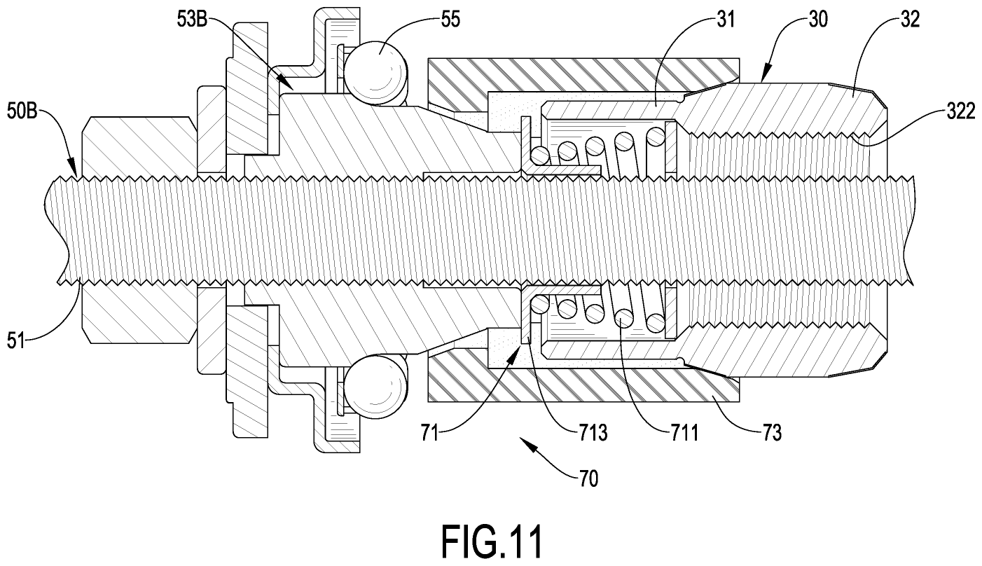

FIG. 12 is a perspective view of a brake pad of the bicycle hub kit in FIG. 7.

### DETAILED DESCRIPTION OF PREFERRED EMBODIMENT

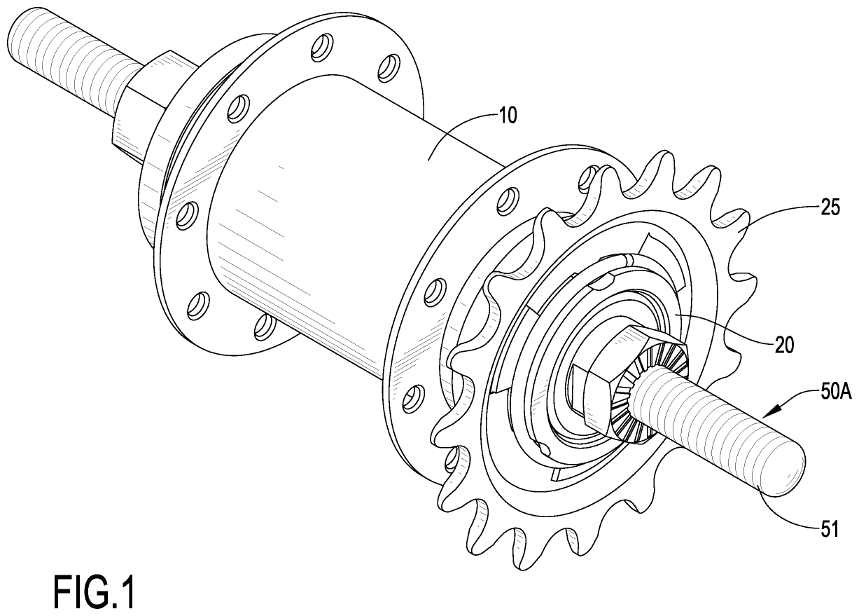

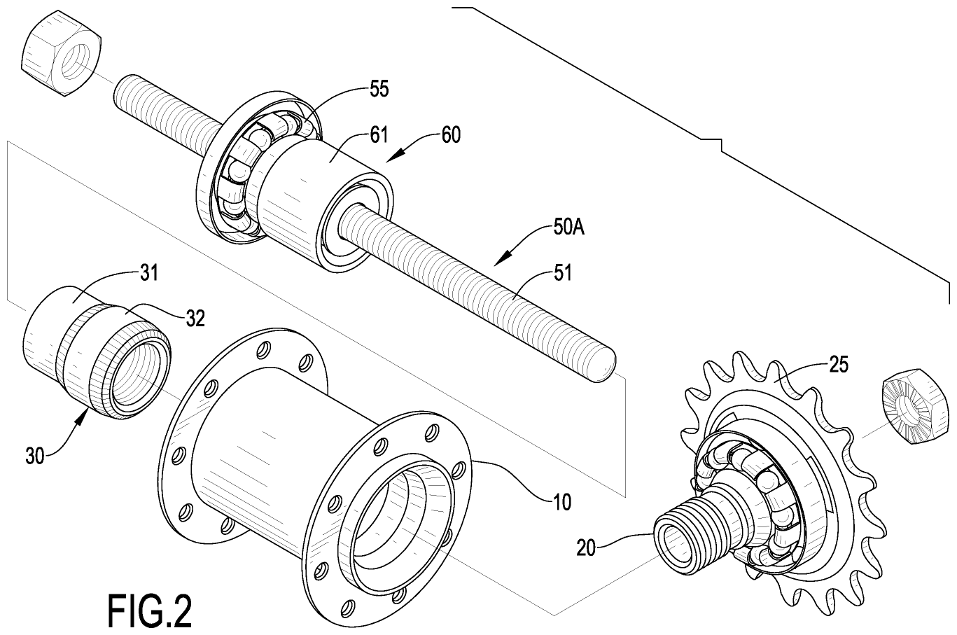

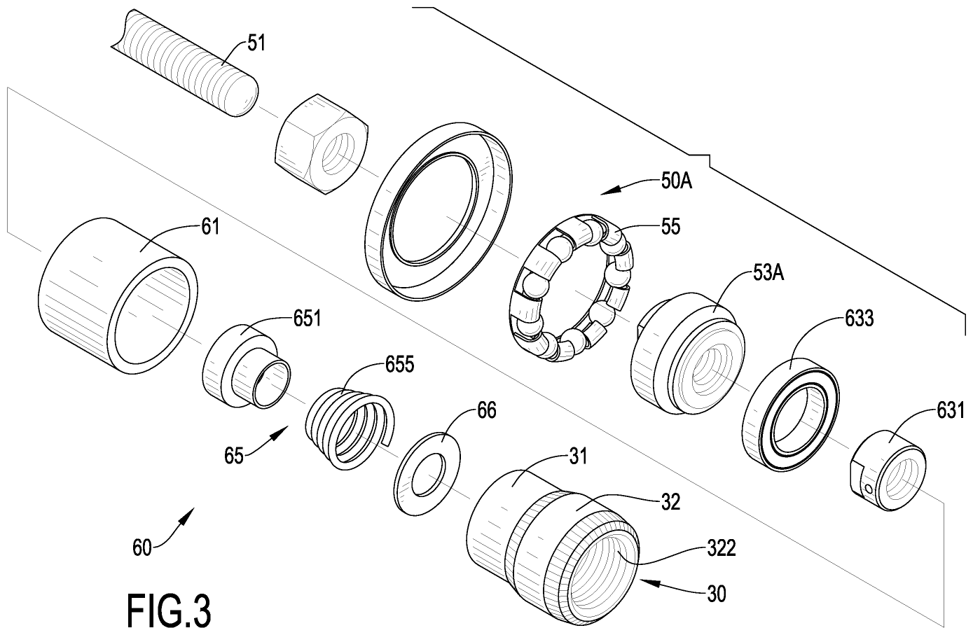

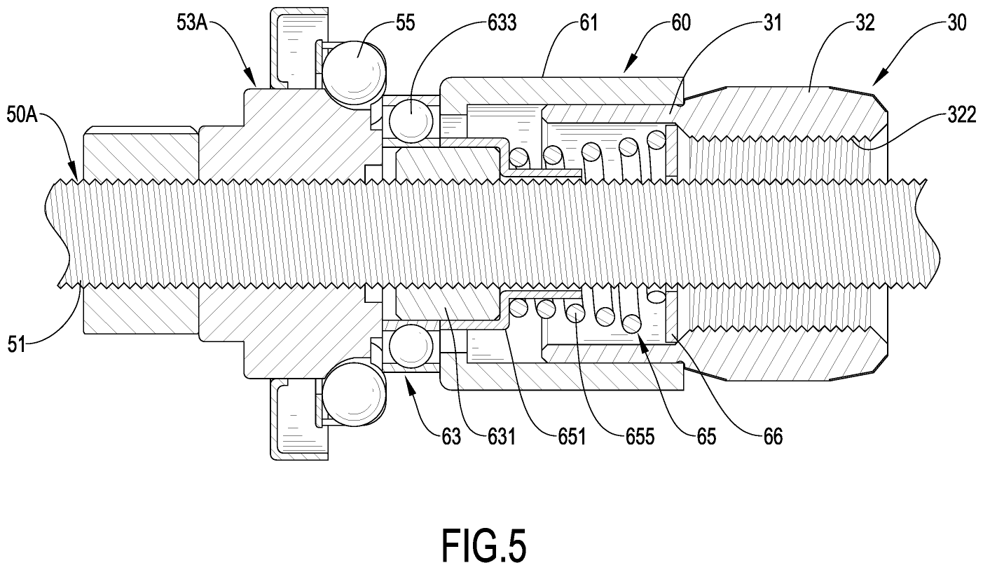

With reference to FIGS. 1 to 5, a first embodiment of a bicycle hub kit in accordance with the present invention comprises a hub body 10, a driver 20, a sprocket 25, a clutch sleeve 30, and a shaft kit 50A.

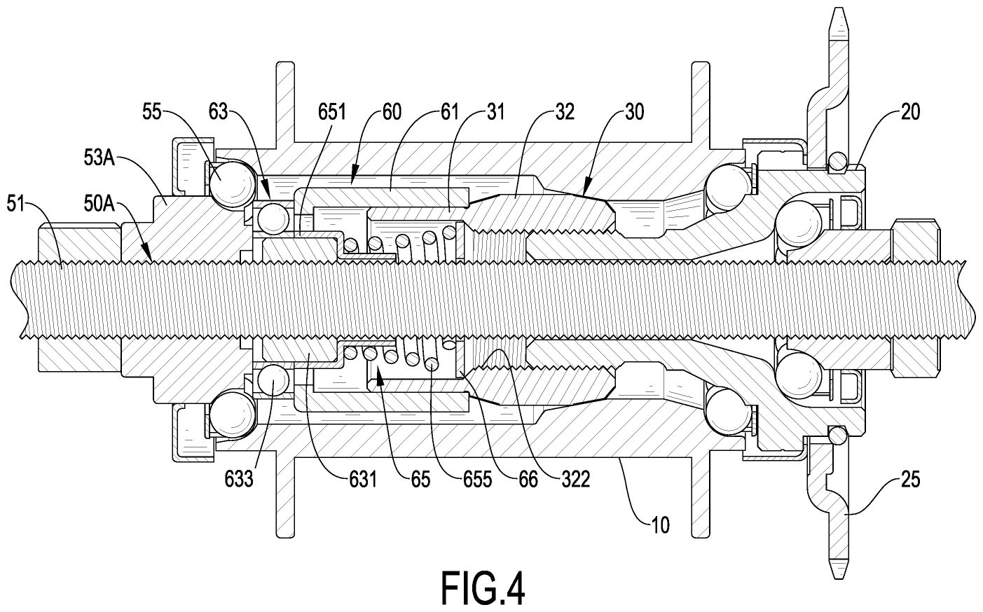

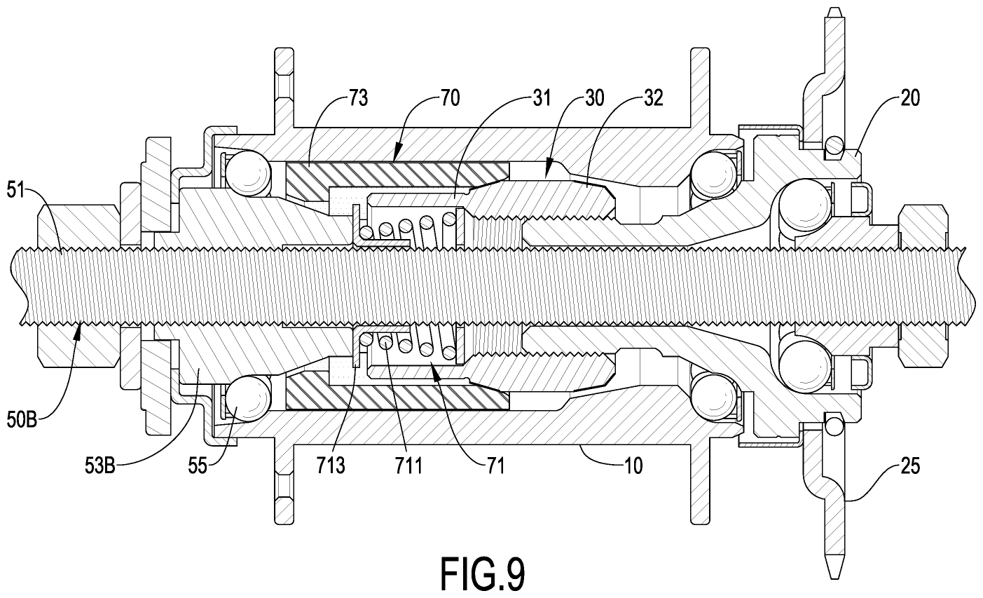

The shaft kit 50A includes a shaft body 51, an end base 53A, a ball retainer 55, and a positioning kit. The positioning kit is disposed between the end base 53A and the clutch sleeve 30 and is selected from a sleeve positioning kit 60 as shown in FIG. 4 and a braking positioning kit 70 as shown in FIG. 9. In the first embodiment, the positioning kit is the sleeve positioning kit 60.

With reference to FIGS. 1 to 5, the hub body 10 surrounds the shaft body 51 and has a first end and a second end opposite to each other. The driver 20 surrounds the shaft body 51, is disposed at the first end of the hub body 10, and has an outer end extending out of the hub body 10 and an inner end extending into the hub body 10. The sprocket 25 is connected to the outer end of the driver 20 and is connected to a front sprocket connected to paddles via a chain ring, and is driven to rotate by the paddles. The clutch sleeve 30 surrounds the shaft body 51 and is disposed inside the hub body 10 and is able to move along the shaft body 51. The clutch sleeve 30 may be a single piece and comprises a first segment 31 extending away from the driver 20 and a second segment 32 adjacent to the driver 20. The second segment 32 surrounds and is connected to the inner end of the driver 20 via a threaded engagement. An outer diameter of the second segment 32 is larger than an outer diameter of the first segment 31.

The shaft body 51 extends through the hub body 10 and the clutch sleeve 30. The end base 53A is fixed to and surrounds the shaft body 51 and extends into the second end of the hub body 10. The ball retainer 55 is sleeved on and surrounds the end base 53A and supports between the hub body 10 and the end base 53A.

The sleeve positioning kit 60 is disposed between the end base 53A and the clutch sleeve 30 and includes a positioning sleeve 61 and a bearing kit 63. The positioning sleeve 61 is sleeved on and surrounds an external periphery of the first segment 31 of the clutch sleeve 30. The bearing kit 63 is disposed between the end base 53A and the positioning sleeve 61 and includes a positioning block 631 and a bearing 633. The positioning block 631 is connected to the shaft body 51 via a threaded engagement. The bearing 633 is sleeved on and surrounds the positioning block 631 and is adjacent to an end of the positioning block 631 facing toward the end base 53A. The bearing 633 has two opposite end surfaces respectively abutting against the end base 53A and the positioning sleeve 61. The bearing 633 includes an inner ring and an outer ring being rotatable relative to the inner ring. The end base 53A has a flat end facing toward the clutch sleeve 30 and abutting against the inner ring of the bearing 633. The positioning sleeve 61 abuts against the outer ring of the bearing 633. The sleeve positioning kit 60 further includes a sleeve spring set 65 and a sleeve washer 66. The sleeve spring set 65 is disposed between the positioning block 631 and the positioning sleeve 61 and includes a spring holder 651 and a sleeve spring 655. The spring holder 651 is sleeved on the positioning block 631 and is adjacent to an end of the positioning block 631 facing away from the end base 53A. The sleeve spring 655 is fixed to the spring holder 651 and extends into the first segment 31 of the clutch sleeve 30. The sleeve washer 66 is adjacent to an end of the sleeve spring 655 away from the end base 53A and is disposed in the first segment 31 of the clutch sleeve 30. The end of the sleeve spring 655 away from the spring holder 651 abuts against the sleeve washer 66.

During a rider reversing paddles to reverse the sprocket 25, the clutch sleeve 30 is limited by the positioning sleeve 61 to be kept in position relative to the shaft body 51, cannot be moved toward the end base 53A along the shaft body 51, and is rotatable relative to the shaft body 51 via the bearing kit 63. Accordingly, the bicycle hub kit does not have the function of a coaster brake.

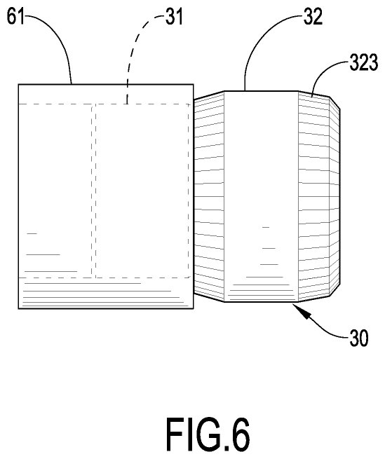

With reference to FIGS. 4 to 6, an outer diameter of the positioning sleeve 61 is larger than an outer diameter of the second segment 32 of the clutch sleeve 30. An outer diameter of the bearing 633 is larger than an inner diameter of an opening of an end of the positioning sleeve 61 facing toward the bearing 633 to prevent the bearing 633 from entering into the positioning sleeve 61 and to ensure the clutch sleeve 30 is able to smoothly rotate. An outer diameter of the sleeve washer 66 is larger than the inner diameter of the second segment 32 of the clutch sleeve 30, so the sleeve washer 66 is kept inside the first segment 31 of the clutch sleeve 30, is unable to enter the second segment 32 of the clutch sleeve 30, and can conveniently support the sleeve spring 655.

Specifically, the clutch sleeve 30 has an internal thread 322 formed at an inner peripheral surface of the second segment 32 to engage with an external thread on the driver 20. So the clutch sleeve 30 can be driven by the driver 20. The clutch sleeve 30 has anti-slip textures 323 formed at the external surface of the second segment 32 to increase friction.

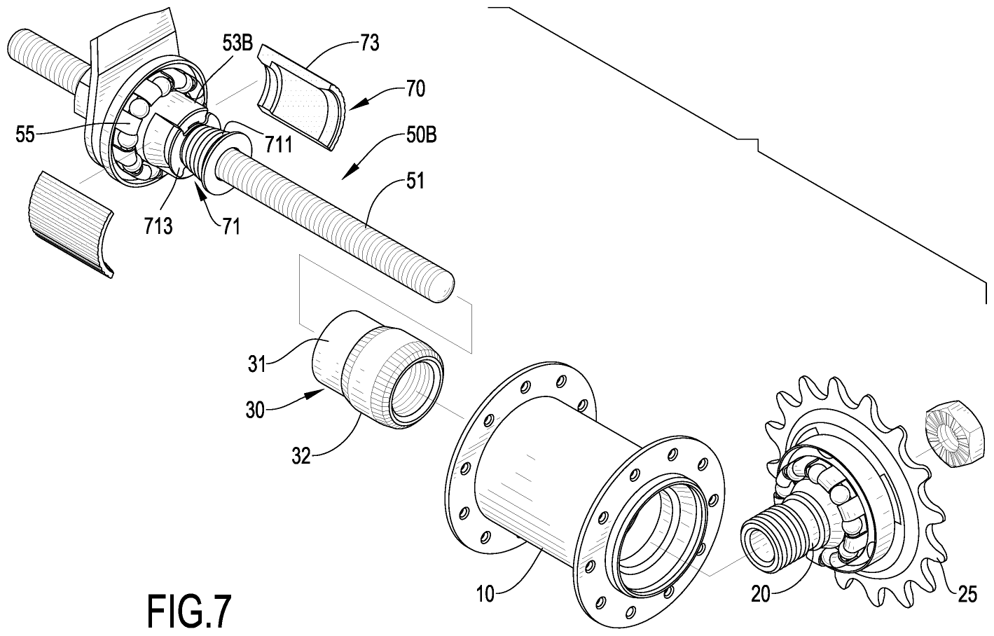

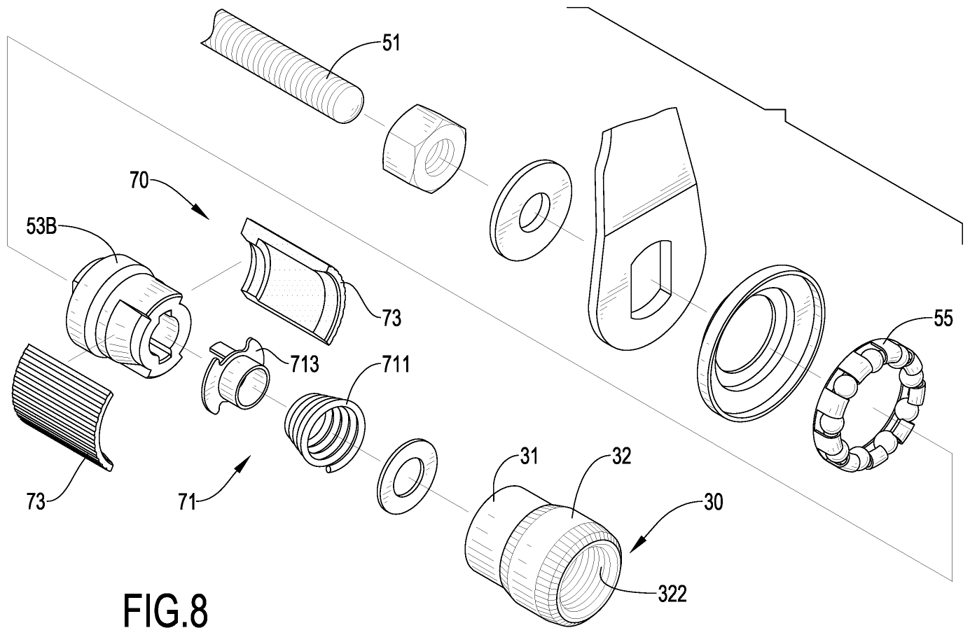

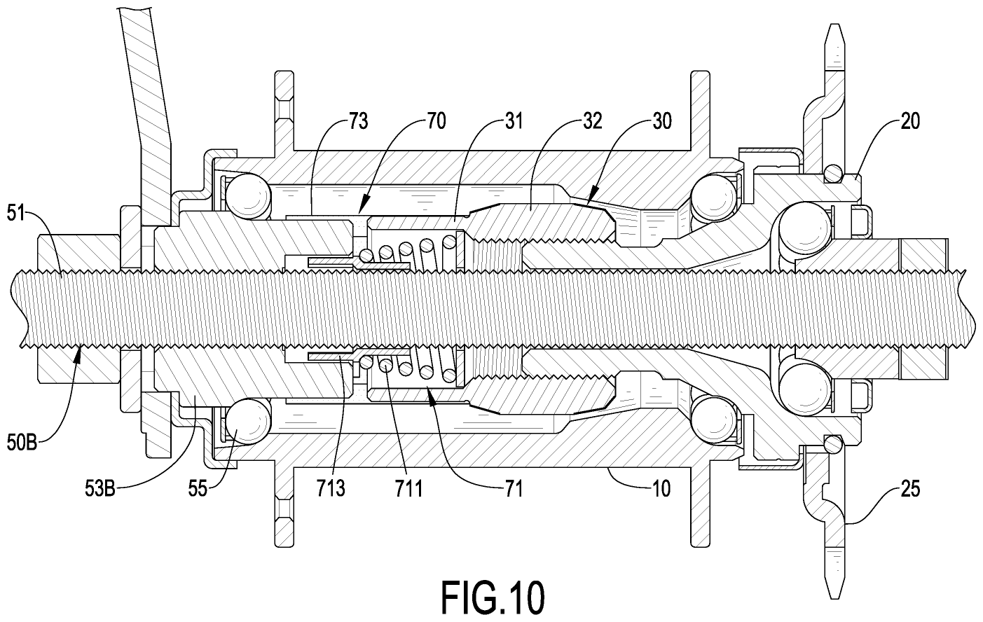

With reference to FIGS. 7 to 10, in the second embodiment, the positioning kit of the shaft kit 50B is a braking positioning kit 70. The braking positioning kit 70 comprises a braking spring set 71 and at least one brake pad 73. The braking spring set 71 is disposed between the end base 53B and the clutch sleeve 30. The braking spring set 71 includes a braking spring 711 and a positioning holder 713. The positioning holder 713 is fixed to an end of the braking spring 711 facing toward the end base 53B. The braking spring 711 extends into the first segment 31 of the clutch sleeve 30. The at least one brake pad 73 is disposed between an internal peripheral surface of the hub body 10 and outer peripheries of the clutch sleeve 30 and the end base 53B. When the sprocket 25 is rotated reversely, the clutch sleeve 30 is driven by the driver 20 to move toward the end base 53B. The at least one brake pad 73 is pushed by the second segment 32 of the clutch sleeve 30 to move toward and abut against the internal peripheral surface of the hub body 10 to brake the hub body 10.

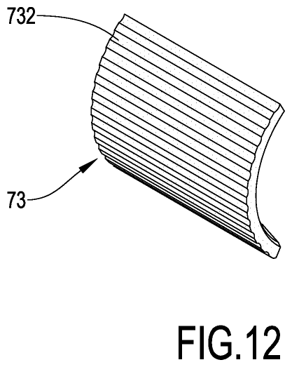

With reference to FIGS. 7, 8, and 12, each brake pad 73 is curved for fitting the outer peripheries of the clutch sleeve 30 and the end base 53B. Whereby, an assembling space can be reduced. Each brake pad 73 has a concave surface facing the outer peripheries of the clutch sleeve 30 and the end base 53B, a convex surface facing the internal surface of the hub body 10, and multiple grooves 732 formed in the convex surface at spaced intervals. Roughness at the convex surface of the brake pad 73 can be increased via the multiple grooves 732, and the friction between the brake pad 73 and the hub body 10 is increased to improve the braking effect. The outer periphery of the end base 53B has a tapered surface facing the clutch sleeve 30. Each brake pad 73 abuts against the tapered surface of the outer periphery of the end base 53B. The at least one brake pad 73 may include two said brake pads 73 disposed at diametrically opposite sides of the end base 53B to enhance the braking effect.

When the coaster brake is needed, the shaft kit 50A is detached from the hub body 10 and is replaced with the shaft kit 50B. The sleeve positioning kit 60 is replaced with the braking positioning kit 70. The positioning sleeve 61 and the bearing kit 63 are removed, the braking spring set 71 is disposed between the end base 53B and the clutch sleeve 30, and the at least one brake pad 73 is disposed inside the hub body 10. When the sprocket 25 is driven to rotate reversely, the clutch sleeve 30 is driven by the driver 20 rotating reversely to move toward the end base 53B, the at least one brake pad 73 is pushed toward the internal peripheral surface of the hub body 10 by the second segment 32 of the clutch sleeve 30 and rubs the internal peripheral surface of the hub body 10 to slow down and brake the hub body 10.

When the coaster brake is not required, the shaft kit 50B is detached from the hub body 10 and is replaced with the shaft kit 50A. The braking positioning kit 70 is replaced with the sleeve positioning kit 60. The braking spring set 71 and the at least one brake pad 73 are removed, and the positioning sleeve 61 and the bearing kit 63 are disposed between the end base 53A and the clutch sleeve 30. When the sprocket 25 is driven to rotate reversely, the clutch sleeve 30 is kept in position by the positioning sleeve 61, is unable to be move toward the end base 53A, and is rotatable relative to the shaft body 51.

Accordingly, the bicycle hub kit can be transformed between with and without a coaster brake. By alternating the shaft kit 50A/50B, the hub body 10 does not have be detached from a wheel set. The user can easily replace the shaft kit 50A/50B by himself/herself free from reconnecting the bicycle hub kit to the spokes and wheel set, thereby saving time and labor and reducing maintenance costs.

What is claimed is:

1. A bicycle hub kit comprising:
a hub body having a first end and a second end;
a driver disposed at the first end of the hub body and having
an outer end extending out of the hub body; and
an inner end extending into the hub body;
a sprocket connected to the outer end of the driver;
a clutch sleeve moveably disposed inside the hub body and having
a first segment extending away from the driver; and
a second segment adjacent to the driver, surrounding and connected to the inner end of the driver, and having an outer diameter being larger than an outer diameter of the first segment; and
a shaft kit comprising
a shaft body extending through the hub body and the clutch sleeve;
an end base fixed to and surrounding the shaft body and extending into the second end of the hub body;
a ball retainer sleeved on and surrounding the end base and supporting between the hub body and the end base; and
a positioning kit disposed between the end base and the clutch sleeve; wherein
the positioning kit is selected from the group consisting of a sleeve positioning kit and a braking positioning kit;
the sleeve positioning kit includes
a positioning sleeve sleeved on and surrounding an external periphery of the first segment of the clutch sleeve; and
a bearing kit disposed between the end base and the positioning sleeve and including
a positioning block connected to the shaft body via a threaded engagement; and
a bearing sleeved on and surrounding the positioning block and having two opposite end surfaces respectively abutting against the end base and the positioning sleeve;
the braking positioning kit includes
a braking spring set disposed between the end base and the clutch sleeve and including
a braking spring extending into the first segment of the clutch sleeve; and
at least one brake pad disposed between an internal peripheral surface of the hub body and outer peripheries of the clutch sleeve and the end base;
when the positioning kit is the sleeve positioning kit, the clutch sleeve is kept positioned by the positioning sleeve;
when the positioning kit is the braking positioning kit, the clutch sleeve is driven to move along the shaft body by the driver.

2. The bicycle hub kit as claimed in claim 1, wherein the end base has a flat end facing toward the clutch sleeve.

3. The bicycle hub kit as claimed in claim 2, wherein
the sleeve positioning kit includes a sleeve spring set and a sleeve washer;
the sleeve spring set is disposed between the positioning block and the positioning sleeve and includes a spring holder and a sleeve spring;
the spring holder is sleeved on the positioning block and is adjacent to an end of the positioning block facing away from the end base;
the sleeve spring is fixed to the spring holder and extends into the first segment of the clutch sleeve; and
the sleeve washer is disposed to an end of the sleeve spring away from the end base.

4. The bicycle hub kit as claimed in claim 1, wherein an inner diameter of the first segment of the clutch sleeve is larger than an inner diameter of the second segment of the clutch sleeve.

5. The bicycle hub kit as claimed in claim 1, wherein the clutch sleeve has an internal thread formed at an inner peripheral surface of the second segment of the clutch sleeve.

6. The bicycle hub kit as claimed in claim 3, wherein
an outer diameter of the positioning sleeve is larger than an outer diameter of the second segment of the clutch sleeve;
an outer diameter of the bearing is larger than an inner diameter of an opening of an end of the positioning sleeve facing toward the bearing; and
an outer diameter of the sleeve washer is larger than an inner diameter of the second segment of the clutch sleeve.

7. The bicycle hub kit as claimed in claim 1, wherein each of the at least one brake pad is curved and has a convex surface and multiple grooves recessed in the convex surface at spaced intervals.
